(19) United States
(12) Patent Application Publication
(10) Pub. No.: US 2016/0244996 A1
(43) Pub. Date: Aug. 25, 2016

(54) Panic actuator for a locking post on a closure

(71) Applicant: Julian Michael Svenson, Cornwall (CA)

(72) Inventor: Julian Michael Svenson, Cornwall (CA)

(21) Appl. No.: 14/544,830

(22) Filed: Feb. 24, 2015

(51) Int. Cl. E05B 65/10; E05C 1/14

(52) U.S. Cl. CPC E05B 65/1073; E05C 1/14

(57) ABSTRACT

A panic actuator having a base with an operator rotatably mounted on the base. The operator can be rotated on the base by a first force applied to the operator on one side of the base to transmit a second force from the operator on the other side of the base. A locking post on a folding closure, the post having a locking unit with a sliding latch within the post, employs the actuator. The actuator is mounted on the locking unit within the post to extend both within the locking unit to contact the latch and outside the post to operate the actuator.

### BACKGROUND OF THE INVENTION

1. Field of the Invention

This invention relates to a panic actuator for installation on a locking post for a folding closure. The invention also relates to a locking post on a folding closure having the panic actuator.

2. Description of the Related Art

The panic actuator is used, in an emergency, to quickly unlock the folding closure, without requiring the use of a key, so it can be opened. Panic actuators such as panic bars are well known for use with swinging closures to open the closures quickly in an emergency. The use of panic bars on folding closures is known as shown in U.S. Pat. No. 4,383,569 to Labelle but the installation is quite complicated in allowing the folding closure to fold. Panic actuators operated with a short paddle are also known for use on closures. An example is shown in U.S. Pat. No. 3,869,159 to Charles L. Eads. The paddle in the example normally extends laterally from the post the actuator is installed on. If installed on a folding closure, the paddle can interfere with the folding of the closure. In addition, the paddle is exposed so it is more likely to be damaged. Being exposed, the paddle is also more likely to be inadvertently operated. Further, many of the known paddle panic actuators are quite complicated in construction.

### SUMMARY OF THE INVENTION

It is the purpose of the present invention to provide a panic actuator for use on a locking post on a folding closure which actuator is simple in construction and operation and which can be easily installed on the locking post while minimizing interference with the folding operation of the closure. It is another purpose of the present invention to provide a simple panic actuator, with a single moving part, that can be easily and simply installed on the locking posts of folding closures already installed.

It is another purpose of the present invention to provide a locking post for a folding closure, the post incorporating the panic actuator. The panic actuator is simple in construction and easily installed. The actuator can be installed on a post having a channel in the side walls of the post, the actuator located in the channel, to minimize the chance of damaging the panic actuator and minimizing the chance of inadvertent operation of the post.

In one aspect of the invention, a panic actuator is provided for mounting on a locking post in a closure. The actuator has a base, with a top and bottom joined by a side, and an operator adjacent the side of the base. The operator is rotatably mounted, by a first section on the operator, on a pin projecting from the side of the base near the top of the base. The operator, in one position, has a second section spaced above the top of the base and spaced across the base from the first section. A third section of the operator is spaced below the bottom of the base and also spaced across the base from the first section. The three sections form the corners of a triangle.

In another aspect of the invention, there is a locking post for a folding closure having front and rear walls and side walls, a lock unit within the post, and a sliding latch within the lock unit movable through the front wall between a locked position outside the post and an unlocked position within the post. A panic actuator, having a base and an operator rotatably connected to the base, is mounted by its base on the lock unit within the post. When the latch is in the locked position, the operator projects out of the post through a post side wall and the operator extends into the lock unit to contact the latch. The operator is rotatable to move the latch from the locked position to the unlocked position.

### BRIEF DESCRIPTION OF THE DRAWINGS

FIG. 1 shows a side view of the panic actuator in a first position;

FIG. 2 shows a side view of the panic actuator in a second position;

FIG. 3 shows a rear view of the panic actuator in the first position;

FIG. 4 is a cross-section view of a typical locking post having a latch operated by a cylinder lock;

FIG. 5 is a top view, partly broken away, of a typical lock unit used with the post shown in FIG. 4;

FIG. 6 is a perspective view of the latch in the lock unit;

FIG. 7 is a view similar to FIG. 5 but with the top side wall of the lock unit removed;

FIG. 8 is a view similar to FIG. 5, but partly cut away and showing the panic actuator installed on the lock unit;

FIG. 9 is cross-section view of the post showing the actuator installed;

FIG. 10 is a partial cross-section view of the lock unit with the actuator installed;

FIG. 11 is a detail view showing a handle on the post to operate the actuator;

FIG. 12 shows the lock unit and actuator on a post with channels in the side walls of the post;

FIG. 13 shows an alternative construction of the base of the actuator;

FIG. 14 shows a side view of a modified operator for the panic actuator; and

FIG. 15 shows a side view of the operator in FIG. 14.

### DESCRIPTION OF THE PREFERRED EMBODIMENT

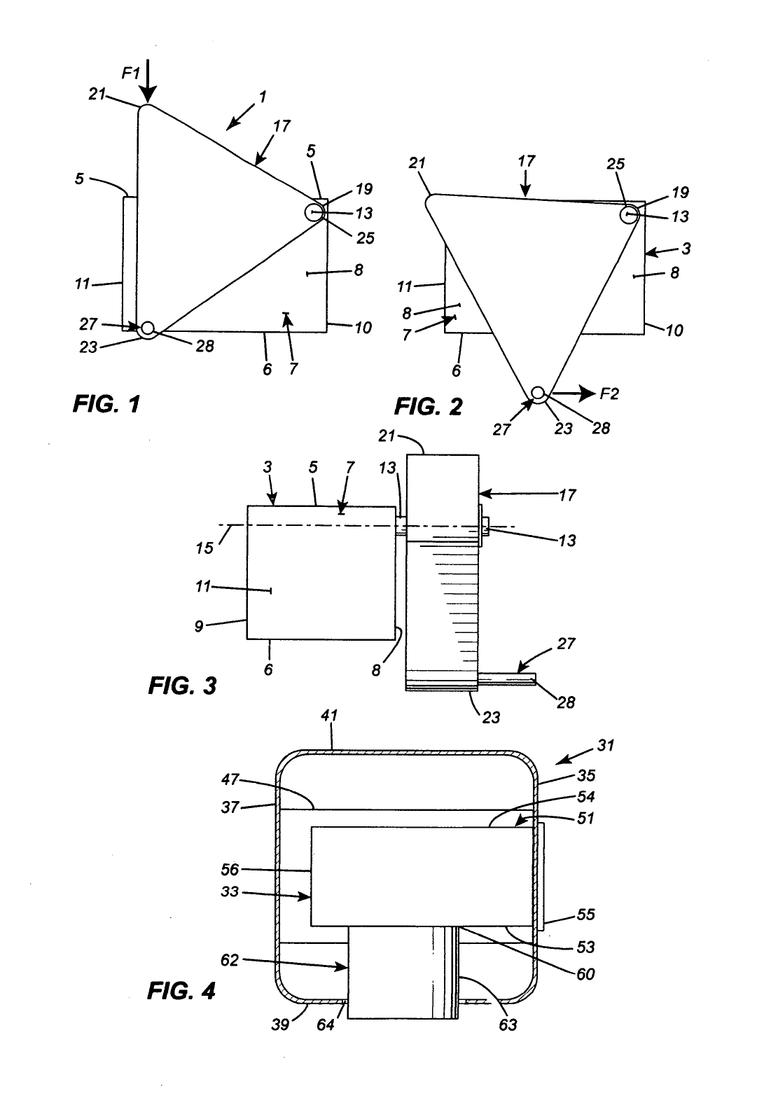

The invention in one aspect, as shown in FIGS. 1-3, is directed toward a panic actuator 1 for mounting within the locking post of a folding closure. The actuator 1, as shown in FIG. 1, has a base 3 with a top and bottom 5, 6 joined by a side 7. The side 7 comprises a pair of opposed end walls 8, 9 and a pair of opposed side walls 10, 11 A cylindrical pin 13 is mounted on the base 3, projecting transversely from end wall 8, away from the other end wall 9, and near both the top 5 and side wall 10. The actuator 1 has an operator 17 rotatably mounted on the pin 13. The operator 17 is generally in the shape of a thick, triangular plate which lies adjacent end wall 8 of the base 3. The operator has first, second and third sections 19, 21 and 23 at the three corners respectively of the plate. The operator 17 has an opening 25 in the first section 19 through which the cylindrical pin 13 is passed to rotatably mount the operator 17 on the pin 13. When mounted on the pin 13 the operator 17 extends transversely to the pin 13, and is adjacent the end section 8 of the post. Suitable means (not shown) on the end of the pin 13 retain the operator 17 on the pin 13.

In a first position of the operator 17, as shown in FIG. 1, the operator 17 angles upwardly from the first section 19 to the second section 21 which second section is spaced above the top 5 of the base 3 and close to vertical alignment with the side wall 11 of the base. Still in the first position, the operator 17 also is angled downwardly from the first section 19 to the third section 23 which third section is spaced below the bottom 6 of the base 3 and close to vertical alignment with the side wall 11. The third section 23 has a push element 27 extending laterally away from the operator 17 and from the base 3. The push element 27 can be a push rod 28 which rod is generally parallel with the pin 13.

The operator 17 can be rotated from the first position shown in FIG. 1 to a second position as shown in FIG. 2. In the second position the second section 21 of the operator is now adjacent the top 5 of the base 3 and is now also close to the side wall 11. The third section 23 has moved from near alignment with the side wall 11 of the base to near alignment with the other side wall 10. The push rod 28 has also moved with the third section 23 to near the other side wall 10. The actuator 1 has been described with it in the position shown in the drawings, but it can obviously be used in any position.

The actuator 1 operates to translate a force F1, applied to the operator 17 while in its first position, which force acts downwardly on the second section 21 of the operator in one direction nearly aligned with the side wall 11, and toward the top 5 of the base 3, to a force F2 applied by the push rod 28 in a generally transverse direction to the one direction and generally following the bottom 6 of the base 3 opposite the top 5 toward the other side wall 10. The transverse direction of force F2 is also laterally spaced away from the force F1 since the push rod 28 extends laterally from operator 3.

The above actuator 1 can be installed in a typical locking post 31 on a folding closure, the post 31 having a standard, known, lock unit 33 installed within it as shown in FIG. 4. The post 31 has a front wall 35 and a rear wall 37, parallel to the front wall 35, the front and rear walls joined by two parallel post side walls 39, 41. The post front and rear walls 35, 37 can be mounted on longitudinally spaced apart spacers 47 within the post. The post side walls 39, 41 can be detachably mounted to the sides of the front and rear walls 35, 37 or they can be integral with the front and rear walls as shown in FIG. 4. Preferably, the post side walls 39, 41 are detachable to make it easier to install lock units in the post.

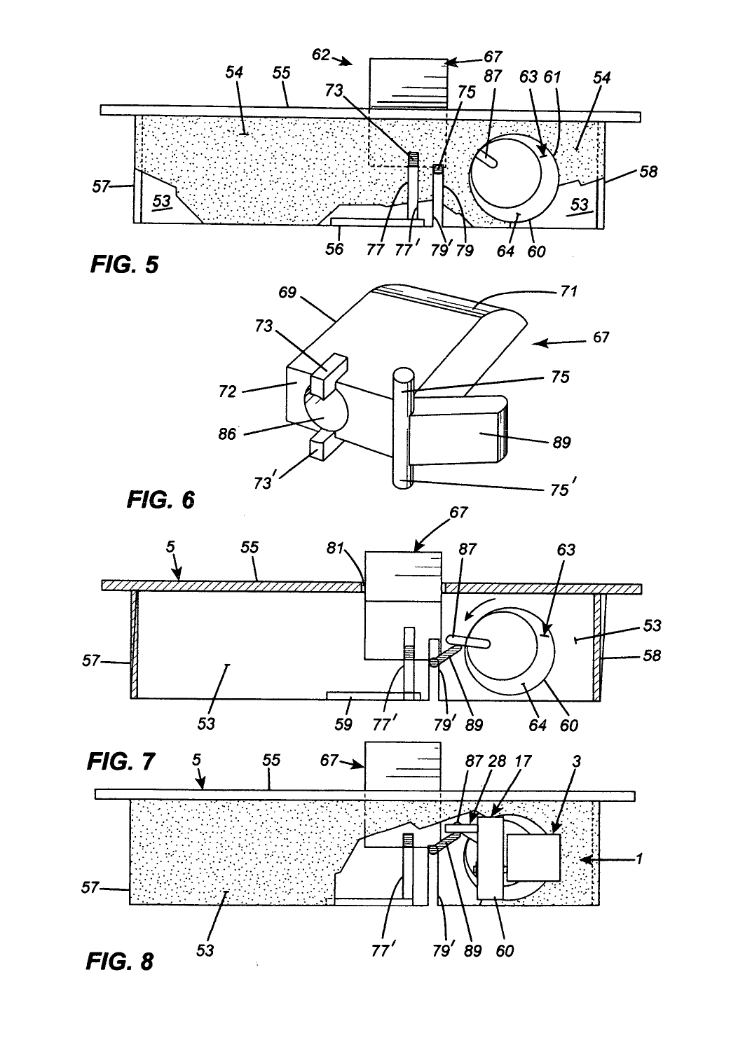

The lock unit 33, as shown in FIGS. 4-5, is preferably of a type known as a quarter turn lock unit and is well known. A typical unit is the 4530 Series Standard Duty Deadlatch sold by Adams Rite. The unit has a relatively flat casing 51 with spaced apart casing side walls 53, 54 which are parallel to the post side walls 39, 41 when the lock unit 33 is installed within the post 31 as shown in FIG. 4. The casing side walls 53, 54 are joined by casing front and rear walls 55, 56. Rear wall 56 can be a partial wall providing some access to within the casing. End walls 57, 58 are joined to the side walls 53, 54 and front wall 55. The casing side walls 53, 54 have aligned, cylindrical lock openings 60, 61 at one end of the casing 51. The lock unit 33 carries a lock mechanism 62 which has a standard cylinder lock 63 which is threadably mounted at one end 64 within one lock opening 60 in one casing side wall 53, the cylinder lock 63 projecting out of the casing 51 from opening 60 and out of the post 31 through an opening 64 in post side wall 39 as shown in FIG. 4. The cylinder lock 62 could alternatively be mounted in the other opening 61 in the other casing side wall 54 depending on how the lock unit 33 is to be used in the post 31.

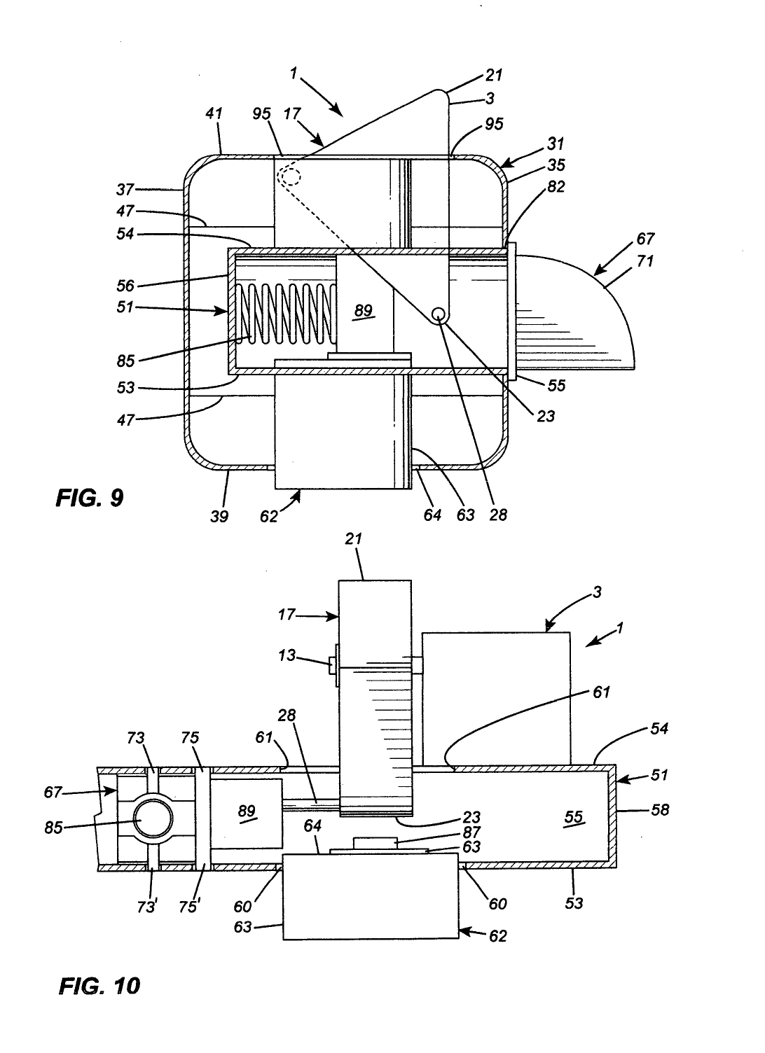

The lock unit 33 also carries a latch 67 which extends transversely across the casing 51. The latch 67, as shown n FIGS. 6-9 has a latch body 69 extending rearwardly from the head 71 of the latch. The rear 72 of the latch body 69 is shaped to have a pair of top 73, 75 and bottom 73′, 75′ guide tabs respectively projecting from the rear of the latch body to slide in top slots 77, 79 and bottom slots 77′, 79′ respectively in the casing side walls 53, 54. The tabs 73, 75 guide the latch 67 for movement between a locked position where the latch 67 projects out of openings 81, 82, as is known, in the casing front wall 57 and the post front wall 35 respectively, and an unlocked position where the latch 67 is withdrawn within the post 31 and casing 51. The latch 67 travels between the locked and unlocked positions in a direction perpendicular to the longitudinal axis of the post 31. A compression spring 85 is mounted between the rear 72 of the latch body 69 and the casing rear wall 59 to bias the latch 67 to its locked position. A circular depression 86 is provided in the rear 72 of the latch body 69 to receive and retain an end of the spring 83.

The cylinder lock 62 can be operated with a key to rotate a finger 87 at its one end 64 about a quarter turn to move the latch 67 back within the post 31, against the spring 83, from its locked position to its unlocked position, as is known. The finger 87 would contact a short arm 89 on the rear 72 of the latch 67 as the finger 87 is rotated on the end 63 of the cylinder lock 62. The arm 89 extends generally laterally from the latch 67 into the path of movement of the finger 87. The construction and operation of the lock unit described above is known and is generally standard. It is understood that the construction of the latch and the casing, and the mounting of the latch in the casing can vary, but the latch is normally spring biased to project laterally from the casing to a locking position and operation of the cylinder lock can move the latch back into the casing to an unlocked position.

In accordance with another aspect of the present invention, a panic actuator 1 can be installed on the post 31 to allow the latch 67 to be unlocked without the use of the cylinder lock 63 in an emergency. The installation would involve, as shown in FIGS. 8-10 using the unused existing opening 61 in the casing side wall 54 near the other post side wall 41 opposite the cylinder lock 63. An opening 95 would be provided in the other post side wall 41 aligned with the opening 61 in the casing side wall 54 to accommodate the actuator 1 as will be described. The panic actuator 1 would be mounted with the bottom 6 of its base 3 on the outside of the casing side wall 54. The second section 21 of the operator 17 would extend up out of the post 31 through the opening 95 in the other post side wall 41. The third section 23 of the operator 17 would extend through the opening 61 in the casing side wall 54 into the casing 51 and would be located adjacent the arm 89 of the latch 67 when the latch is in the locked position, as shown in FIG. 10. The push rod 28 on the third section 23 of the operator 17 would contact the arm 89 on the latch 67 above the finger 87 on the cylinder lock 63. The arm 89 would be contacted on its surface which faces the front wall 35 of the post. The base 3 would be fastened in place by suitable fasteners such as screws (not shown) passing through the base 3 into and through the casing side wall 54. The base 3 would be fastened to the casing side wall 54 before the casing was installed within the post.

In operation, in an emergency, a person would merely have to press the second section 21 of the operator 17 projecting from out the opening 95 inwardly toward the post side wall 41 to swing the push rod 28 on the third section 23 of the operator 17 in a direction against the arm 89 on the latch 67. Continued pushing will move the latch 67 toward the side wall 37 of the post 31, against the spring 85 to withdraw the latch 67 into the post, via the arm 89 being pushed. Withdrawal of the latch would unlock the post and thus the closure the post is on. After the closure has been unlocked and opened, and the operator 17 released, latch 67 is moved back to the lock position by the spring 85, the arm 89 on the latch 67 returning the operator 17 to its locking position with the second section 21 of the operator 17 rising away from the side wall 41 of the post 31.

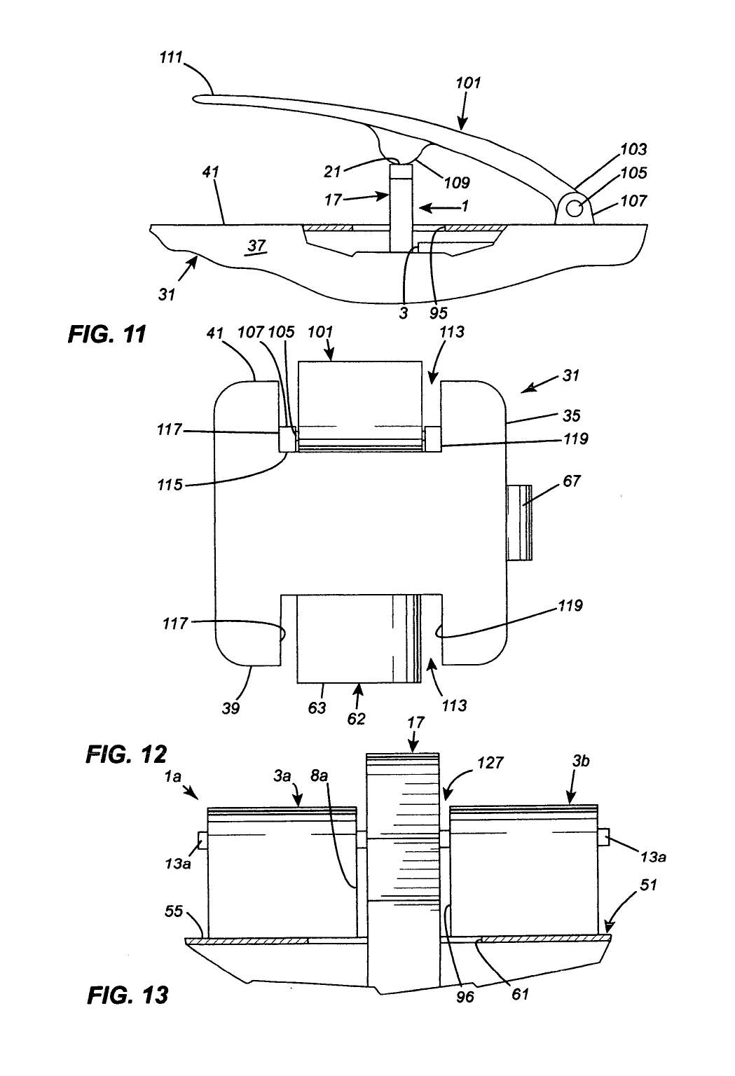

Preferably, the actuator 1 would be provided with a handle 101 to make it easier to rotate the operator 17. The handle 101, as shown in FIG. 11 would be pivotably mounted at one end 103 to the one post side wall 41 by a pivot pin 105 mounted in the one end 103 extending transverse to the handle and projecting from the sides of the handle. The pivot pin 105 would be mounted on a pivot pin mount 107 fixed to the post side wall 41. The handle 101 would overlie the exposed second section 21 of the operator 17, the handle aligned with the post 31, the operator 17 extending up through an opening 95 in the side wall 41 of the post. A small ridge 109 on the underside of the handle 101 would overlie the second section 21 of the operator 17. Pressing the free end 111 of the handle 101 down about its pivot pin 105 would press the second section 21 of the operator 17 down to rotate the operator 17 to withdraw the latch 67. The actuator 1 employed allows its handle 101 to be mounted in a position aligned with the post so the handle will not interfere with folding of the closure. The handle 101 could be replace by a button (not shown) attached to the exposed second section 21 of the operator.

The post 31 could be provided with a channel 113 in each of the post side walls 39, 41 as shown in FIG. 12. The channel 113 would preferably extend the length of the post and, in side wall 39, would be wide enough and deep enough to receive at least a major portion of the cylinder lock 63, and, in opposite side wall 41, to at least partly receive the handle 101 and its pivot pin mount 107. The opening 95 in the post side wall 41, for exposing the second section 21 of the operator 17, would be in the channel bottom wall 115. The base 3 (not shown) would also extend above the channel bottom wall 115 within the channel 113, extending up through the opening 95 which would be enlarged to accommodate the base 3. The pivot pin mounting 107 can be mounted on the bottom wall 115 transverse to the channel 113. The channel side walls 117, 119 provide handles for pulling the post 31 and thus the attached closure in either direction. Locating the handle 101 and the cylinder lock 63 at least partly in the channels 113 would help protect both from damage.

The base 3 of the actuator 1 has been shown as a single member with the operator 17 mounted at one end of it. However the actuator 1a could have a base that is separated into two base members 3a, 3b, as shown in FIG. 13, with the cylindrical pin 13a mounted in both members and extending across a gap 127 separating the members. The operator 17 would be rotatably mounted in the gap 127 on the pin 13a, the operator adjacent an end surface 8a, 9b of each base member 3a, 3b respectively. The split base members 3a, 3b, with the operator 17 between the base members, would provide a stronger actuator 1a. The actuator 1a would span a side segment of the opening 61 in the casing 51, when mounted on the casing wall 55 to partly overlie the opening.

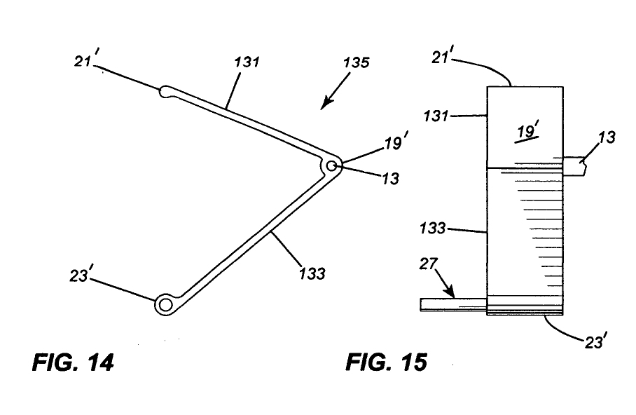

The operator 17 of the actuator has been shown as a triangular member with three sections at the corners of the triangular member. The operator 17′ could comprise an angled, rigid, strap-like, member having two arms 131, 133 joined at their ends to form a corner 135 as shown in FIGS. 14-15. The arms 131, 133 extend radially outwardly from the corner 135 to define between them, very roughly, an angle β that is close to a right angle. The corner 135 forms the first section 19′ of the operator 17′ and is slightly enlarged and used to rotatably mount the operator 17′ on the cylindrical pin 13 mounted on the base 3. The end of the first arm 131 can be slightly enlarged and rounded and forms the second section 21′ of the operator 17′. The end of the second arm 133 can also be slightly enlarged and rounded and forms the third section 23′ of the operator 17′. A push member 27 can extend from the third section 23′ transversely of the actuator 17′. The operator 17′ rotates in the same fashion as the operator 17. When the operator 17′ is mounted on the pin 13, it is parallel and adjacent the end wall 8 of the base 3 in the same manner as actuator 17. The operation of actuator 17′ is the same as the operation of actuator 17.

The above description is meant to be exemplary only, and one skilled in the art will recognize that changes may be made to the embodiments described without departing from the scope of the invention disclosed. Modifications which fall within the scope of the present invention will be apparent to those skilled in the art. In light of a review of this disclosure, such modifications are intended to fall within the appended claims.

I claim:

1. A panic actuator for mounting on a locking post in a closure, the actuator having a base; the base having a top and bottom joined by a side; an operator adjacent the side of the base, the operator rotatably mounted, by a first section on the operator, on a pin projecting from the side of the base, near the top of the base; the operator having, in a first position of the operator, a second section spaced above the top of the base and spaced across the base from the first section, and a third section spaced below the bottom of the base and also spaced across the base from the first section; the three sections forming the corners of a triangle.

2. A panic actuator as claimed in claim 1 including a push member extending laterally from the third section of the operator away from the base.

3. A panic actuator as claimed in claim 1 wherein the side of the actuator has two opposed side sections and two opposed end sections, the first section on the operator adjacent one side section and one end section.

4. A panic actuator as claimed in claim 3 including a push member extending laterally from the third section of the operator away from the base.

5. A panic actuator as claimed in claim 4 wherein the operator is rotatable from the first position to a second position where the second section is moved from a position spaced from both one side section and one end section to a position adjacent the one side section and adjacent the one end section and where the third section is moved from a position near the one end section to a position near the other end section.

6. A panic actuator as claimed in claim 2 wherein the operator is in the form of a triangular plate with the first, second and third sections of the operator formed by the first, second and third corner portions of the triangular plate; the plate parallel with the first end surface of the base.

7. A panic actuator as claimed in claim 2 wherein the operator is in the form of a bent rod with the first, second and third sections of the operator formed at the bend portion of the rod, the free end of a first arm extending from the bend and the free end of a second arm extending from the bend respectively; the first arm angled above the top of the base with the free end over the one end section of the base; the second arm angled below the bottom of the base and below the one end section; the bent rod parallel with the other end section of the base.

8. A panic actuator as claimed in claim 2 wherein the operator in the first position has the second section and the third section generally aligned with the side of the base.

9. A panic actuator as claimed in claim 2 wherein the operator can be rotated from the first position to a second position, the second section in the second position generally aligned with the first section of the operator and the side of the base.

10. A panic actuator as claimed in claim 2 wherein the base is in two sections separated by a gap, the pin mounted in both base sections and extending across the gap, the operator in the gap adjacent both base sections and rotatably mounted on the pin.

11. A locking post for a folding closure having front and rear walls and side walls, a lock unit within the post, a sliding latch within the lock unit movable through the front wall between a locked position outside the post and an unlocked position within the post; a panic actuator having a base and an operator rotatably connected to the base, the panic actuator mounted by its base on the lock unit within the post with the operator projecting out of the post through a post side wall and with the operator extending into the lock unit to contact the latch when the latch is a locked position, the operator rotatable to move the latch from the locked position to the unlocked position.

12. A locking post for a folding closure, the locking post having front and rear walls joined by post side walls; a lock unit mounted within the post spaced from the post side walls, the lock unit having a casing holding a lock mechanism having a latch slidable in the casing and through the front wall of the post between unlocked and locked positions; a spring biasing the latch outwardly from the casing and post to the locked position; a panic actuator having a base and an operator having a first section to rotatably mount the operator on the side of the base adjacent the base; the actuator mounted within the post by its base on the outside of the casing adjacent an opening in the casing; the operator having a second section extending through an opening in a post side wall, and a third section extending into casing through the opening in the casing to contact the latch in its locked position whereby rotation of the operator by pushing the extended second section of the operator back toward the front wall will cause the third section of the actuator to move the latch against the spring back to an unlocked position.

13. A locking post as claimed in claim 12 wherein the casing has two spaced apart casing side walls parallel with the post side walls, the casing side walls have aligned cylindrical openings, one of the cylindrical openings being the opening the third section of the operator extends through.

14. A locking post as claimed in claim 12 wherein the post side walls each have a longitudinal channel recessed into the post, the second section of the operator extending into the channel of said one post side wall.

15. A post as claimed in claim 12 wherein the operator is a triangular plate with the first section being one corner of the triangle, the second section being a second corner of the triangle and the third section being the third corner of the triangle, the third section having a push rod extending laterally from the plate away from the base of the actuator.

16. A post as claimed in claim 12 wherein the operator is a bent strap-like member, the first section being the bend section in the member, the second section being at the end of a first arm of the member extending radially from the bend section, the third section being at the end of a second arm extending radially from the first section at an angle to first arm, the third section having a push rod extending laterally from the bent rod away from the base of the actuator.

17. A post as claimed in claim 12 having a handle for operating the panic actuator, the handle rotatably mounted at one end on a pivot pin, the pivot pin extending transverse to the post and mounted on the post side wall through which side wall the second section of the operator extends, the second section spaced a short distance from the pivot pin, the handle aligned with the post and overlying and contacting the second section of the actuator whereby depression of the handle will push the second section of the operator toward the post, rotating the operator and causing the third section to move the latch to an unlocked position within the post.

18. A post as claimed in claim 17 wherein the post side walls each have a longitudinal channel, the pivot pin and handle within the channel in the post side wall they are mounted on, the second section of the operator extending from within the post into the channel.
